(19) United States
(12) Patent Application Publication
(10) Pub. No.: US 2019/0045764 A1
(43) Pub. Date: Feb. 14, 2019

(54) FISHING LURE HAVING A CURVED PLATE

(71) Applicant: Rapala VMC Corporation, Helsinki (FI)

(72) Inventors: Stephen Gibson, Columbia, SC (US); Hironori Kitade, Kaga (JP); Bart Rosen, Lakeville, MN (US)

(21) Appl. No.: 15/923,250

(22) Filed: Mar. 16, 2018

Related U.S. Application Data
(60) Provisional application No. 62/543,008, filed on Aug. 9, 2017.

(51) Int. Cl. A01K 85/18; A01K 95/00; A01K 85/14

(52) U.S. Cl. CPC A01K 85/18; A01K 85/14; A01K 95/00

(57) ABSTRACT

A fishing lure, along with its methods of manufacture and use, is provided. The fishing lure may have a curved plate comprising a concave surface and a convex surface. A first attachment loop may be attached onto the concave surface, and a second attachment loop may be attached onto the convex surface. A lure body may be attached, directly or indirectly, to the connection ring.

### PRIORITY INFORMATION

The present application claims priority to U.S. Provisional Application No. 62/543,008 filed on Aug. 9, 2017, which is incorporated by reference herein.

### FIELD OF TECHNOLOGY

The present invention is directed to fishing lures, along with their methods of manufacture and use. In particular, a fishing lure is provided that includes a curved plate.

### BACKGROUND

Sport fishing is enjoyed around the world. From fresh water to salt water, a wide variety of fish species exist. Fishermen employ a variety of equipment and tackle depending upon the water being fished, the time of day, the species of fish sought, personal choice, and many other factors. A fishing lure, sometimes referred to as an artificial lure, is frequently a part of such equipment and tackle.

Fishing lures are typically designed and decorated with the goal of replicating or mimicking the movement and appearance of a food source for the particular fish being sought. For example, such lure may take on the shape of a minnow, tadpole, frog, mouse, insect, salamander, another fish, or such other food source. The fisherman's hope is that by having a lure closely resembling or acting like a source of food, fish will be enticed into biting the lure.

Lures can also be designed with features that make the lure realistic in a functional manner. Fins, diving planes, spinners, rattles and the like may be added in order to make the lure move and sound like a food source. Some lures may be specifically designed to operate on the water surface while others may function only when below. Generally speaking, the lure's overall shape, the weight of the lure, the design of any lip on the lure, and the location of the point of attachment to the fishing line can affect the swim path of the lure during retrieval.

There is an ongoing need in the art for an improved fishing lure that attracts fish to bite the lure.

### BRIEF DESCRIPTION

Aspects and advantages will be set forth in part in the following description, or may be obvious from the description, or may be learned through practice of the invention.

A fishing lure is generally provided, along with its methods of manufacture and use. In one embodiment, the fishing lure has a curved plate comprising a concave surface and a convex surface. A first attachment loop is attached onto the concave surface, and a second attachment loop is attached onto the convex surface. A lure body is attached, directly or indirectly, to the connection ring.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 shows a perspective view of an exemplary fishing lure according to one embodiment of the present invention;

FIG. 2 shows a side view of the exemplary fishing lure of FIG. 1;

FIG. 3 shows a top view of the exemplary fishing lure of FIG. 1; and

FIG. 4 shows a close-up side view of the curved plate of the exemplary fishing lure of FIGS. 1-3 with reference lines and points.

Repeat use of reference characters in the present specification and drawings is intended to represent the same or analogous features or elements of the present invention.

### DETAILED DESCRIPTION OF PARTICULAR EMBODIMENTS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

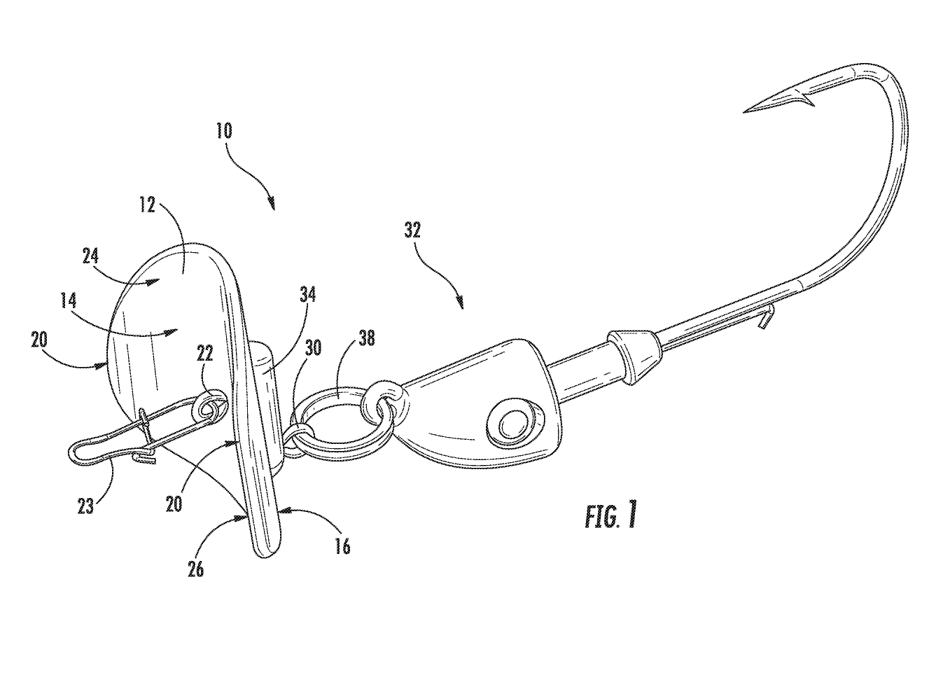

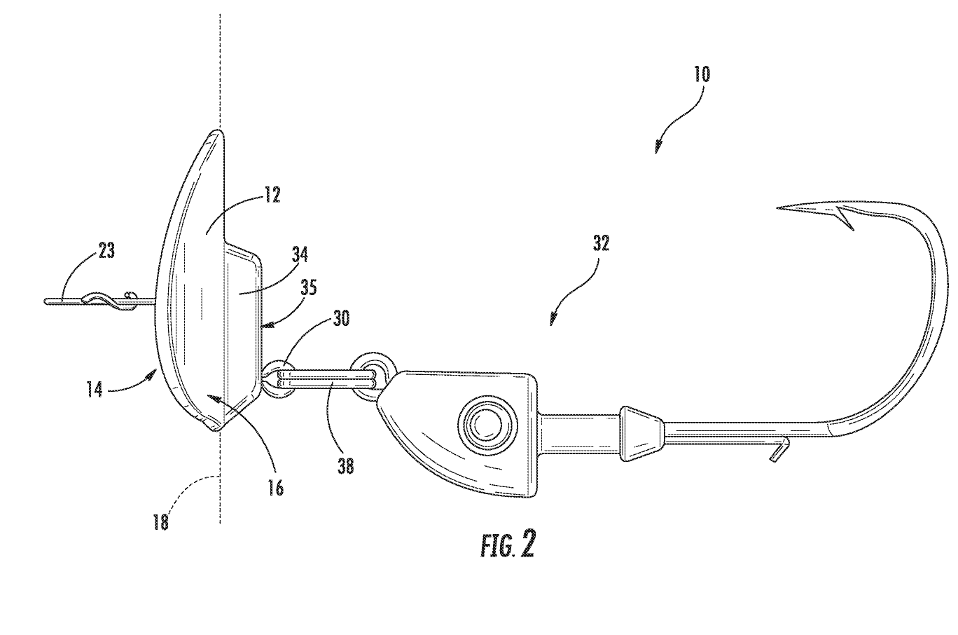

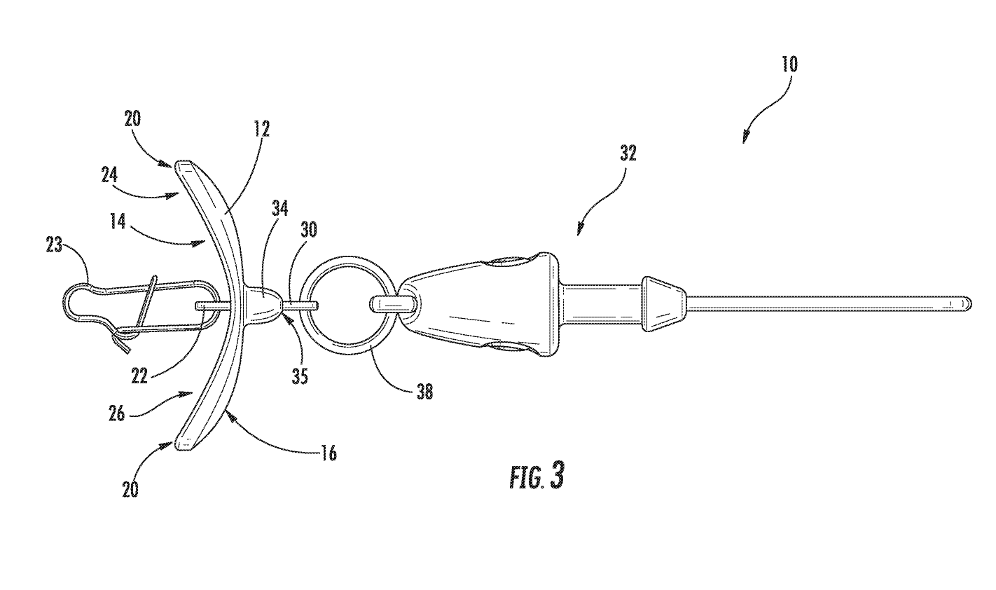

A fishing lure is generally provided, along with methods of its manufacture and use. Generally, the fishing lure may be fished/retrieved to have an action that attracts a targeted fish to bite/strike. Referring to FIGS. 1-3, a fishing lure 10 is generally shown including a curved plate 12 with a concave surface 14 and a convex surface 16. The curved plate 12 may generally be designed to cause the trailing lure body 32 to mimic a swimming bait fish. That is, the curved plate 12 interacts with the water when being pulled through to cause a side-to-side movement that is transferred to the trailing lure body 32, which makes the lure body 32 look like a swimming bait fish. Such an effect may intice a fish to strike the lure body 32.

In one embodiment, the curved plate 12 has a curvature defined from center vertical line 18 forward on both sides to define the concave surface 14 (forward of the fishing lure 10) and the convex surface 16 (facing aft toward the trailing lure body 32). Though the curvature of the concave surface 14 of the curved plate 12 may be circular in particular embodiments, the curvature may be non-circular in other embodiments. For example, in most embodiments, the curvature is not a fixed radius across the concave surface 14 of the curved plate 12, but rather the curvature varies from being flatter in the middle (e.g., around 0 to about 0.05 mm⁻¹ curvature along the vertical centerline) to more curved at the outer edges (e.g., about 0.05 mm⁻¹ to about 1 mm⁻¹ at the edges).

A first attachment loop 22 is attached onto the concave surface 14, with the first attachment loop 22 being positioned to attach to a fishing line connected to fishing tackle (e.g. a rod and reel combination). A snap connection 23 is shown attached to the first attachment loop 22 for connection to the fishing line, such that the fishing line is connected indirectly to the first attachment loop 22 (e.g., through the snap). In other embodiments, the fishing lure 10 may be tied directly onto the first attachment loop 22 (e.g., via a loop knot or a fixed knot).

In the embodiment shown, the first attachment loop 22 is positioned on the concave surface 14 along center vertical line 18. Due to this positioning, the resistance of the water as the curved plate 12 is moved through the water causes horizontal side-to-side pivoting, generally about the center vertical line 18 as the axis of pivot. In one embodiment, the sides 24, 26 of the concave surface 14 may be generally equal length on either side of the center vertical line 18. For instance, the sides 24, 26 of the concave surface 14 may generally be mirror images of each other on either side of the center vertical line 18. That is, the concave surface 14 has a first side 24 on one side of the center vertical line 18 and a second side 26 on the opposite side of the center vertical line 18, with the first side 24 and the second side 26 being mirror images of each other.

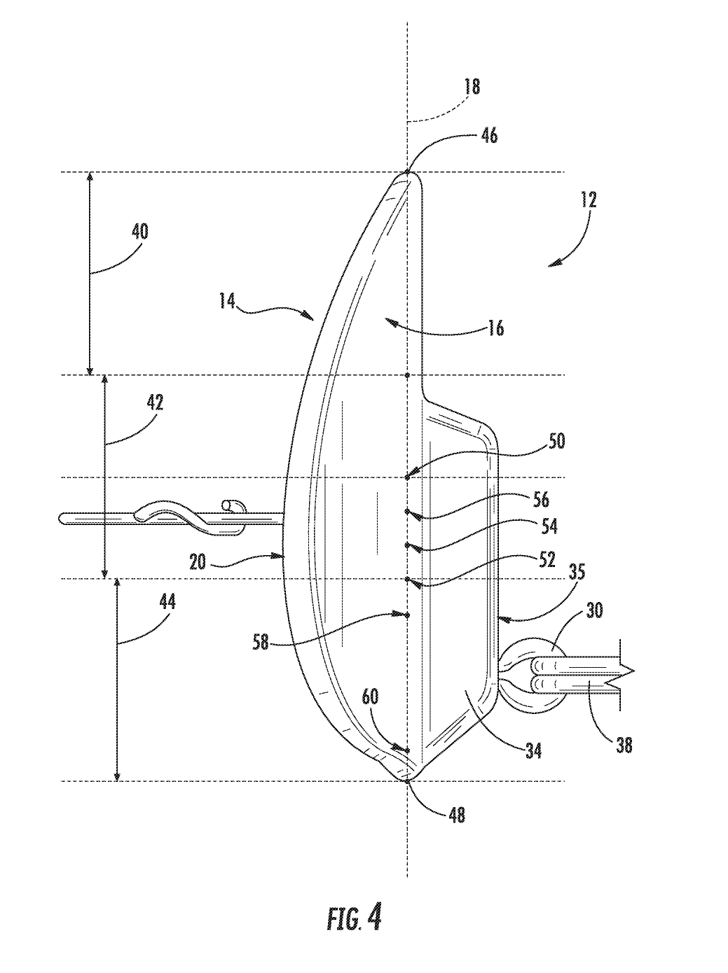

The positioning of the first attachment loop 22 on the concave surface 14 may influence the depth of the fishing lure 10 when pulled through the water. The first attachment loop 22 is, in the embodiment shown, positioned on the concave surface 14 in a center segment along the center vertical line 18 defined on the concave surface 14 (i.e., within a center portion of the total length along the center vertical line 18). For example, referring to FIG. 4, three equal length segments 40, 42, 44 are defined along the total height of the concave surface 14 along the center vertical line 18 (from top point 46 to bottom point 48), with the center segment 42 defining the middle 33% of the center vertical line 18 (with the first attachment loop 22 positioned within the center segment). In one particular embodiment, the first attachment loop 22 is positioned along the center vertical line 18 within the center segment 42 and below the center point 50 of the center vertical line 18. For example, if the bottom point 48 of the center vertical line 18 is at 0% of the height, the center point 50 is at 50% of the height and the top point 46 is 100% of the height, then the first attachment loop 22 may be positioned along the center vertical line 18 above a point 52 at about 33.3% of the height and below the center point 50. For instance, the first attachment loop 22 may be positioned along the center vertical line 18 above a point 54 at about 40% of the height and below 56 a point at about 45% of the height. Due to this positioning, more surface area of the concave surface 14 is positioned above the first attachment loop 22 to provide a counter-balance, during retrieving through the water, to the lure attached to the reinforcement rib 34 positioned on the convex surface 16 and the positioning of the second attachment loop 30 discussed below.

A second attachment loop 30 is attached onto the convex surface 16, so as to provide a connection to a trailing lure body 32 (directly or indirectly). In the embodiment shown, the second attachment loop 30 is attached indirectly to the convex surface 16 through a reinforcement rib 34 positioned along the convex surface 16. As shown, the reinforcement rib 34 is oriented substantially vertically along center vertical line 18 of the convex surface 16. A majority of the reinforcement rib 34 may be positioned below a center point along the center vertical line 18 of the convex surface 16 so as to provide a connection point below the center point to counterbalance the water pushing on the top of the curved plate during use. Thus, the reinforcement rib 34, along with the positioning of the second attachment loop, may help to keep the curved plate 12 vertically oriented while moving through the water. In one embodiment, the reinforcement rib 34 extends at least from a bottom edge of the convex surface 16 through a center point of the center vertical line 18 defined along the convex surface 16.

In the exemplary embodiment shown, the second attachment loop 30 is attached to a back surface 35 of the reinforcement rib 34. The second attachment loop 30 may be positioned below a point at 33% of the height of the convex surface 16. For example, referring to FIG. 4, if the bottom point 48 of the center vertical line 18 is at 0% of the height, the center point 50 is at 50% of the height and the top point 46 is 100% of the height, then the second attachment loop 30 may be positioned below a point 58 at 25% of the height of the convex surface 16 and above a point 60 at 10% of the height of the convex surface 16 (e.g., below a point at 20% of the height of the convex surface 16 and above a point at 15% of the height of the convex surface 16).

A connection ring 38 is shown attaching the second attachment loop 30 to a trailing lure body 32, shown in the form of a jig head. The jig head includes an attachment loop on a forward end 20 of the jig head, with a hook shaft extending from a rear end of the jig head opposite from the forward end 20. As known in the art of fishing, a fishing lure 10 adornment (such as a jig tail, a paddletail, a worm, etc.) or other bait may be attached along the hook shaft extending from the jig head. Other fishing lure 10 bodies may be utilized with the curved plate 12, as desired.

The connection ring 38 may be a split ring as shown, or may be any other connection (e.g., a tied connection, a wire, a welded ring, etc.). However, in other embodiments, the lure body 32 may be attached directly to the second attachment loop 30.

As stated, the first attachment loop 22 is attached to a fishing line connected to fishing tackle (e.g., a rod and reel combination). The angler begins to retrieve the fishing by reeling in fishing line that is connected to the first attachment loop 22 of on the concave surface 14 of the curved plate 12. As the fishing lure 10 is pulled forward at the point of connection (first attachment loop 22) with the fishing line (not shown), the curved plate 12 drags against the water and causes the lateral movement (side to side) of the curved plate 12 through the water. This lateral movement, in turn, causes the second connection loop to move side-to-side in the water. As such, the jig head of the lure body 32 moves side-to-side to mimic a bait fish swimming through the water.

This written description uses exemplary embodiments to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fishing lure, comprising:
a curved plate comprising a concave surface and a convex surface, wherein a first attachment loop is attached onto the concave surface, and wherein a second attachment loop is attached onto the convex surface; and
a lure body attached, directly or indirectly, to the curved plate.

2. The fishing lure as in claim 1, wherein the curved plate has a curvature defined from a center vertical line forward on both sides to define the concave surface and the convex surface.

3. The fishing lure as in claim 2, wherein the curvature varies over the surface of the concave surface of the curved plate.

4. The fishing lure as in claim 2, wherein the concave surface has a first side on one side of the center vertical line and a second side on the opposite side of the center vertical line, and wherein the first side and the second side are mirror images of each other.

5. The fishing lure as in claim 1, wherein the first attachment loop is positioned on the concave surface along a center vertical line.

6. The fishing lure as in claim 5, wherein the first attachment loop is positioned on the concave surface within a center segment along the center vertical line defined on the concave surface.

7. The fishing lure as in claim 5, wherein the first attachment loop is positioned on the concave surface along the center vertical line below a center point of the height of the concave surface and above a point at about 33.3% of the height of the concave surface.

8. The fishing lure as in claim 5, wherein the first attachment loop is positioned on the concave surface along the center vertical line below a point at about 45% of the height of the concave surface and above a point at about 33.3% of the height of the concave surface.

9. The fishing lure as in claim 5, wherein the second attachment loop is attached indirectly to the convex surface through a weight positioned along the convex surface.

10. The fishing lure as in claim 9, wherein the weight is oriented substantially vertically along a center vertical line of the convex surface.

11. The fishing lure as in claim 10, wherein a majority of the weight is positioned below a center point along the center vertical line of the convex surface.

12. The fishing lure as in claim 10, wherein the weight extends at least from a bottom edge of the convex surface through a center point of the center vertical line defined along the convex surface.

13. The fishing lure as in claim 10, wherein the second attachment loop is attached to a back surface of the weight.

14. The fishing lure as in claim 13, wherein the second attachment loop is positioned below a point at 33% of the height of the convex surface.

15. The fishing lure as in claim 13, wherein the second attachment loop is positioned below a point at 25% of the height of the convex surface and above a point at 10% of the height of the convex surface.

16. The fishing lure as in claim 13, wherein the second attachment loop is positioned below a point at 20% of the height of the convex surface and above a point at 15% of the height of the convex surface.

17. The fishing lure as in claim 1, wherein the lure body is attached to the second attachment loop indirectly through a connection ring.

18. The fishing lure as in claim 17, wherein the connection ring is a split ring.

19. The fishing lure as in claim 1, wherein the lure body includes a jig head having an attachment loop on a forward end.

20. The fishing lure as in claim 19, wherein a hook shaft is attached to the jig head extending from a rear end of the jig head opposite from the forward end.
